(19) United States
(12) Patent Application Publication
(10) Pub. No.: US 2016/0032422 A1
(43) Pub. Date: Feb. 4, 2016

(54) PROCESS FOR PREFERENTIAL DISSOLUTION OF IRON IN THE PRESENCE OF TITANIUM

(71) Applicant: THE CHEMOURS COMPANY TT LLC, Harrisburg, PA (US)

(72) Inventors: DAVID RICHARD CORBIN, WEST CHESTER, PA (US); WILLIAM B. HAMBLETON, WILMINGTON, DE (US); CARL ANDREW MENNING, NEWARK, DE (US)

(21) Appl. No.: 14/810,804

(22) Filed: Jul. 28, 2015

Related U.S. Application Data
(60) Provisional application No. 62/032,726, filed on Aug. 4, 2014.

(51) Int. Cl. C22B 34/12; C08K 3/22; C22B 3/16

(52) U.S. Cl. CPC C22B 34/124; C22B 3/165; C08K 3/22; C08K 2003/2241; C08K 2003/2265

(57) ABSTRACT

Disclosed herein are processes for selectively solubilizing iron from a substrate material containing both titanium and iron, such as ilmenite ore. In one embodiment, the process comprises contacting a substrate material comprising iron and titanium with an aqueous solution of an extractant selected from the group consisting of malonic acid, a malonic acid salt, citric acid, a citric acid salt, and mixtures thereof, at a temperature between about 25° C. and about 160° C. for a time sufficient to form an aqueous leachate comprising iron and titanium, and solids comprising titanium; wherein the leachate has a titanium content of 25 weight percent or less, based on the sum of the iron and the titanium contents of the leachate on a weight basis.

### FIELD OF DISCLOSURE

The present invention relates to processes for preferentially leaching iron in the presence of titanium in the production of titanium dioxide.

### BACKGROUND

Titanium dioxide is used as a white pigment in paints, plastics, paper, and specialty applications. Ilmenite is a naturally occurring mineral containing both titanium and iron with the chemical formula FeTiO₃.

Two major processes are currently used to produce TiO₂ pigment—the sulfate process as described in “Haddeland, G. E. and Morikawa, S., “Titanium Dioxide Pigment”, SRI international Report #117” and the chloride process as described in “Battle, T. P., Nguygen, D., and Reeves, J. W., The Paul E. Queneau International Symposium on Extractive Metallurgy of Copper, Nickel and Cobalt, Volume I: Fundamental Aspects, Reddy, R. G. and Weizenbach, R. N. eds., The Minerals, Metals and Materials Society, 1993, pp. 925-943”. Dumon et al (Dumon, J. C., Bull. Inst. Geol. Bassin Aquitaine, 1975, 17, 95-100 and Dumon, J. C., and Vigneaux, M., Phys. Chem. Earth 1977, 11, 331-337) describe the extraction of ilmenite with organic and mineral acids. Removal of iron from titanium dioxide is necessary to obtain the high white color characteristics desired of titanium dioxide pigments.

Both the sulfate and the chloride processes extract titanium and iron from ilmenite, and require further separation steps to isolate titanium. New processes are desired which selectively leach iron from materials containing both titanium and iron, and which provide titanium-enriched, iron-depleted material suitable for producing titanium dioxide pigment. Such processes may require fewer separation steps to obtain titanium dioxide in high purity and may offer economic advantages. New processes for easily removing low levels of iron impurities from titanium dioxide are also desired.

### SUMMARY

In one embodiment, a process is provided, the process comprising the step:

a) contacting a substrate material comprising iron and titanium with an aqueous solution of an extractant selected from the group consisting of malonic acid, a malonic acid salt, citric acid, a citric acid salt, and mixtures thereof, at a temperature between about 25° C. and about 160° C. for a time sufficient to form an aqueous leachate comprising iron and titanium, and solids comprising titanium;

wherein the leachate has a titanium content of 25 weight percent or less, based on the sum of the iron and the titanium contents of the leachate on a weight basis.

In one embodiment, the process further comprises the steps:

b) separating the solids from the leachate to obtain separated solids; and

c) optionally, washing the separated solids with water.

The process may further comprise using the separated solids obtained in step b) or step c) in a process for producing titanium dioxide pigment.

In one embodiment, a titanium-enriched material is provided, the titanium-enriched material obtained by a process comprising the steps:

i) contacting a substrate material comprising iron and titanium with an aqueous solution of an extractant selected from the group consisting of malonic acid, a malonic acid salt, citric acid, a citric acid salt, and mixtures thereof, at a temperature between about 25° C. and about 160° C. for a time sufficient to form a leachate comprising iron and titanium, and solids comprising titanium;

wherein the leachate has a titanium content of 25 weight percent or less, based on the sum of the iron and the titanium contents of the leachate on a weight basis; and

ii) separating the solids from the leachate to obtain separated solids; wherein the separated solids are titanium-enriched relative to the substrate material.

### DETAILED DESCRIPTION

As used herein, where the indefinite article “a” or “an” is used with respect to a statement or description of the presence of a step in a process disclosed herein, it is to be understood, unless the statement or description explicitly provides to the contrary, that the use of such indefinite article does not limit the presence of the step in the process to one in number.

As used herein, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope be limited to the specific values recited when defining a range.

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the term “about” modifying the quantity of an ingredient or reactant employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities. The term “about” may mean within 10% of the reported numerical value, preferably within 5% of the reported numerical value.

As used herein, the term “substrate material comprising iron and titanium” means a mixture of metal oxide species in compound form or forms which include titania (TiO₂) and iron. The substrate material may be natural or synthetic such as a powder, ore or mineral, or a mixture thereof. The substrate material may be a titanium-rich material such as an ore, including ilmenite, anatase, rutile, or perovskite. The substrate material may be obtained in a chlorination or sulfation process for producing titanium dioxide pigment, such as a titanium-rich intermediate or unfinished product, including titanyl hydroxide cake or titanium dioxide pigment. The substrate material includes at least one iron species such as a ferrous or ferric species, for example iron oxides such as FeO, Fe₂O₃, Fe₃O₄, or mixtures thereof.

As used herein, the term “extractant” refers to the carboxylic acids and salts disclosed herein which, when contacted as an aqueous solution with a substrate material under sufficient reaction conditions, enable preferential leaching of iron over titanium from the substrate material.

As used herein, the term “leachate” refers to the homogeneous liquid solution obtained by contacting an aqueous solution of an extractant with a substrate material under sufficient reaction conditions as disclosed herein. The leachate contains solutes which are derived from the substrate material. The solutes include iron and, in some embodiments, titanium. Optionally, additional metals may be present in the leachate.

As used herein, the term “digesting” refers to contacting a substrate material with an aqueous solution of the extractant to obtain an aqueous leachate and solids. The solids comprise the portion(s) of the substrate material which are not solutes in the leachate.

As used herein, the term “malonic acid” refers to propanedioic acid (CAS number 141-82-2), the chemical structure of which can be represented as HO₂CCH₂CO₂H. As used herein, the term “malonic acid salt” refers to monobasic or dibasic salts of malonic acid, and can include one or more salts. Malonic acid salts are also known as malonates.

As used herein, the term “citric acid” refers to 2-hydroxypropane-1,2,3-tricarboxylic acid (CAS number 77-92-9), the chemical structure of which can be represented as HO₂CCH₂CH(CO₂H)CH₂CO₂H. As used herein, the term “citric acid salt” refers to monobasic, dibasic, or tribasic salts of citric acid, and can include one or more salts. Citric acid salts are also known as citrates.

In one embodiment, a process is provided, the process comprising: contacting a substrate material comprising iron and titanium with an aqueous solution of an extractant selected from the group consisting of malonic acid, a malonic acid salt, citric acid, a citric acid salt, and mixtures thereof, at a temperature between about 25° C. and about 160° C. for a time sufficient to form an aqueous leachate comprising iron and titanium, and solids comprising titanium, wherein the leachate has a titanium content of 25 weight percent or less, based on the sum of the iron and the titanium contents of the leachate on a weight basis. The process may further comprise the steps of separating the solids from the leachate to obtain separated solids, and optionally, washing the separated solids with water. The solids comprising titanium, the separated solids, and the washed solids are enriched in titanium content and depleted in iron content relative to the titanium content and iron content of the substrate material prior to contacting with the aqueous solution, and further processing can be performed to produce titanium dioxide from the solids comprising titanium, the separated solids, or the washed solids. In one embodiment, the process further comprises using the solids comprising titanium in a process for producing titanium dioxide pigment. In one embodiment, the process further comprises using the separated solids, optionally after a washing step, in a process for producing titanium dioxide pigment.

In one embodiment, the process comprises contacting a substrate material comprising iron and titanium with an aqueous solution of an extractant selected from the group consisting of malonic acid, a malonic acid salt, citric acid, a citric acid salt, and mixtures thereof, at a temperature between about 25° C. and about 160° C. for a time sufficient to form an aqueous leachate comprising iron and solids comprising titanium, wherein the leachate is essentially free of titanium. As used herein, the term “essentially free of titanium” means a concentration of less than 1 ppm titanium as determined by inductively coupled plasma spectrometry.

The substrate material comprises iron and titanium, and optionally may contain additional metals such as magnesium and manganese. The iron and titanium contents of the substrate material can vary, as can the relative amounts of the two metals. In some embodiments, the iron content of the substrate material is between and optionally includes any two of the following values: less than 0.1 weight percent (wt %), 0.1 wt %, 0.5 wt %, 1 wt %, 2 wt %, 5 wt %, 10 wt %, 15 wt %, 20 wt %, 25 wt %, 30 wt %, 35 wt %, 40 wt %, 45 wt %, 50 wt %, and 55 wt % iron. In some embodiments, the iron content is between and optional includes any two of the following values: 0.0001 wt %, 0.0002 wt %, 0.0005 wt %, 0.001 wt %, 0.002 wt %, 0.005 wt %, 0.01 wt %, 0.02 wt %, 0.05 wt %, and 0.1 wt % iron. In one embodiment, the iron content of the substrate material is between 0.0001 wt % and 0.01 wt % iron. In some embodiments, the iron content is between 0.005 wt % and 0.1 wt % iron. In some embodiments, the titanium content of the substrate material is between and optionally includes any two of the following values: 20 wt %, 25 wt %, 30 wt %, 35 wt %, 40 wt %, 45 wt %, and 50 wt %, titanium. In one embodiment, the substrate material contains from about 15 wt % to about 45 wt % iron and from about 20 wt % to about 45 wt % titanium. In one embodiment, the substrate material contains from about 0.1 wt % to about 4 weight percent iron, and from about 55 wt % to about 65 wt % titanium. In one embodiment, the substrate material contains from about 0.0001 wt % to about 7 wt % iron, and from about 55 wt % to about 60 wt % titanium In one embodiment, the substrate material contains from about 0.0001 wt % to about 52 wt % iron. In one embodiment, the substrate material contains less than 0.1 weight percent iron.

In one embodiment, the substrate material comprises ilmenite ore. As used herein, the term “ilmenite ore” refers to iron titanate with a titanium dioxide content ranging from 35% to 75% by weight. The chemical composition of natural ilmenite ore can vary. It is commonly understood to be ferrous titanate with the formula FeTiO₃. The iron proportions can be higher than the theoretical composition due to admixed hematite or magnetite. An excess of titanium may be present, due to the presence of rutile. In one embodiment, the processes disclosed herein can be used with ilmenites having titanium dioxide content on the lower end of the ilmenite range, for example a titanium dioxide content of 35% to 60% by weight, or a titanium dioxide content of 45% to 55% by weight. In one embodiment, the processes disclosed herein can be used with ilmenites having titanium dioxide content on the higher end of the ilmenite range, for example a titanium content of 50% to 75%, or a titanium dioxide content of 60% to 70% by weight.

In one embodiment, the substrate material comprises titanyl hydroxide cake. As used herein, the term “titanyl hydroxide cake” refers to an amorphous intermediate in titanium dioxide production resulting from hydrolysis of a titanium-rich solution and containing “titanyl hydroxide” solid, which may be calcined to obtain titanium dioxide pigment. The exact chemical identity of “titanyl hydroxide” is not precisely known, in part because the degree of hydration is variable. The “titanyl hydroxide” (titanic acid) is believed to exist as TiO(OH)₂, TiO(OH)₂.H₂O or TiO(OH)₂.nH₂O (where n>1) or mixtures thereof [see J. Barksdale, “Titanium: Its Occurrence, Chemistry and Technology”, 2nd Edition, Ronald Press; New York (1966)]. Titanyl hydroxide cake can be produced by either of the known commercial processes for titanium dioxide production, the chloride process or the sulfate process. Titanyl hydroxide cake can also be produced by other known processes, such as extraction of titanium-rich solutions from digestion of ilmenite by oxalic acid, ammonium hydrogen oxalate, or trimethylammonium hydrogen oxalate, followed by hydrolysis. Although the titanyl hydroxide cake can comprise minor amounts of other inorganic compounds, such as the sulfates, phosphates or chloride residues from the above-mentioned commercially practiced sulfate and chloride processes for the production of titanium dioxide, the weight percent of such inorganic compounds is expected to be less than 0.5 weight percent, or less than 0.3 weight percent, or less than 0.1 weight percent of the dry weight. The present processes disclosed herein may be used advantageously to reduce the iron content of titanyl hydroxide cake in order to produce a higher purity intermediate in the production of titanium dioxide.

In one embodiment, the substrate material comprises titanium dioxide pigment. As used herein, the term “titanium dioxide pigment” refers to titanium dioxide which provides the desired opacity for most applications and has a particle size in the range from 100 to 600 nanometers. Titanium dioxide with a particle size less than 100 nanometers is referred to as nano-sized. Titanium dioxide pigment may have at least three crystalline mineral forms: anatase, rutile and brookite. Rutile crystallizes in the tetragonal crystal system (P42/mnm with a=4.582 Å., c=2.953 Å); anatase crystallizes in the tetragonal crystal system (I41/amd with a=3.7852 . Å, c=9.5139 Å.; brookite crystallizes in the orthorhombic crystal system (Pcab with a=5.4558 Å, b=9.1819 Å, c=5.1429 Å). In one embodiment, the titanium dioxide pigment comprises rutile titanium dioxide, anatase titanium dioxide, or a mixture thereof. In one embodiment, the titanium dioxide pigment comprises rutile titanium dioxide. In one embodiment, the titanium dioxide pigment comprises anatase titanium dioxide. The final titanium dioxide pigment may or may not be coated with additional oxides, such as but not limited to aluminum oxide or silicon dioxide.

Even low levels of iron content can have a deleterious effect on the high white color characteristic of titanium dioxide pigment. The processes disclosed herein may be used advantageously to remove low levels of iron, for example less than 0.1 weight percent iron, or less than 0.01 weight percent iron, from titanium dioxide pigment to improve color of the titanium dioxide pigment. The processes disclosed herein may also be used advantageously to reduce the iron content of titanium dioxide pigment contaminated with iron-containing substances, for example rust.

In some embodiments, the substrate material has an average particle size in at least one dimension in the range of less than 100 nanometers to about 600 nanometers, with 95% or more of the particles below about 600 nanometers in size. In some embodiments, the substrate material has an average particle size of less than about 400 nanometers, or less than about 350 nanometers, or less than about 300 nanometers, or less than about 100 nanometers. The average particle size can be measured, for example using optical microscopy. Smaller sized particles provide a larger surface-area-to-volume ratio and may provide greater access of the extractant to the iron contained in the substrate material, thus enabling more of the iron to be dissolved into the leachate solution.

The substrate material comprising iron and titanium is contacted with an aqueous solution of an extractant at temperature conditions and for a time sufficient to form an aqueous leachate comprising iron and titanium, and solids comprising titanium, as disclosed herein. As a result of the preferential dissolution of iron over titanium during the contacting step, the solids are enriched in titanium content and depleted in iron content, relative to the composition of the substrate material. The preferential dissolution of iron over titanium in the processes disclosed herein provides a leachate containing more iron than titanium.

The relative amounts of iron and titanium contained in the leachate obtained by the processes disclosed herein may be expressed as the ratio of iron to titanium on a molar basis. The extractant solubilizes iron in preference to titanium to produce an aqueous leachate having a ratio of iron to titanium above about 2:1 on a weight basis, for example above 3:1, or for example above 4:1, or above 5:1, or above 6:1, or above 10:1, or above 20:1, or above 50:1, or above 100:1, or above 500:1, or above 1000:1, or even higher.

The amounts of iron and titanium contained in the leachates obtained by the processes disclosed herein may be expressed as weight percent iron and weight percent titanium, based on the sum of the iron and the titanium contents of the leachate on a weight basis. Thus an aqueous leachate having an iron to titanium ratio above about 2:1 can also be expressed as an aqueous leachate having a minimum iron content of 67 wt % iron and a maximum titanium content of 33 wt % titanium, based on the sum of the iron and titanium contents of the leachate on a weight basis. Similarly, an aqueous leachate having an iron to titanium ratio above 3:1 corresponds to an aqueous leachate having a minimum iron content of 75 wt % and a maximum titanium content of 25 wt %; an iron to titanium ratio above 4:1 corresponds to a minimum iron content of 80 wt % and a maximum titanium content of 20 wt %; an iron to titanium ratio above 5:1 corresponds to a minimum iron content of 83 wt % and a maximum titanium content of 17 wt %; an iron to titanium ratio above 6:1 corresponds to a minimum iron content of 86 wt % and a maximum titanium content of 14 wt %; an iron to titanium ratio above 10:1 corresponds to a minimum iron content of 91 wt % and a maximum titanium content of 9 wt %; an iron to titanium ratio above 20:1 corresponds to a minimum iron content of 95.3 wt % and a maximum titanium content of 4.7 wt %; an iron to titanium ratio above 50:1 corresponds to a minimum iron content of 98 wt % and a maximum titanium content of 2 wt %; an iron to titanium ratio above 100:1 corresponds to a minimum iron content of 99.1 wt % and a maximum titanium content of 0.9 wt %; and an iron to titanium ratio above 1000:1 corresponds to a minimum iron content of 99.9 wt % and a maximum titanium content of 0.10 wt %.

The processes disclosed herein provide a leachate having a titanium content of 33 weight percent (wt %) or less, based on the sum of the iron and the titanium contents of the leachate on a weight basis. In one embodiment, the leachate has a titanium content of 25 wt % or less. In one embodiment, the leachate has a titanium content of 20 wt % or less. In one embodiment, the leachate has a titanium content of 17 wt % or less. In one embodiment, the leachate has a titanium content of 14 wt % or less. In one embodiment, the leachate has a titanium content of 10 wt % or less. In one embodiment, the leachate has a titanium content of 5 wt % or less. In one embodiment, the leachate has a titanium content of 2 wt % or less. In one embodiment, the leachate has a titanium content of 1 wt % or less. In one embodiment, the leachate has a titanium content of 0.10 wt % or less. In one embodiment, the leachate comprises iron and is essentially free of titanium, meaning the leachate contains less than 1 ppm titanium as determined by inductively coupled plasma spectrometry.

The extractant is selected from the group consisting of malonic acid, a malonic acid salt, citric acid, a citric acid salt, and mixtures thereof. In one embodiment, the extractant is malonic acid. In one embodiment, the extractant is a malonic acid salt. In one embodiment, the extractant is citric acid. In one embodiment, the extractant is a citric acid salt. Substituted malonic acids bearing a hydroxyl group and/or an alkyl group on the C₂ carbon, wherein the alkyl group is methyl, ethyl, propyl, or butyl, and salts of these acids may also be suitable extractants. It is believed that other useful extractants may include malic acid (also known as hydroxybutanedioic acid), succinic acid (also known as butanedioic acid), salts of these acids, and mixtures thereof. Suitable salts of the extractant carboxylic acids disclosed herein may include as cations lithium, sodium, potassium, rubidium, ammonium, and mixtures thereof.

As used in the contacting step, neither the extractant nor the aqueous solution of the extractant contain mineral acids, for example phosphoric acid, sulfuric acid, or hydrochloric acid. The processes for forming a leachate as disclosed herein exclude a separate step of adding a mineral acid to the extractant, or to the aqueous solution of the extractant, which is employed in the contacting step. In some embodiments, the substrate material may contain adventitious acid, for example a small amount of acid entrained in the substrate material from a previous processing step. If such entrained acid is present, typically the substrate material may contain 0.5 wt % or less of an acid such as oxalic acid, sulfuric acid, or hydrochloric acid.

The aqueous solution of the extractant has a concentration of extractant between about 0.1 M and about 7.4 M. In some embodiments, the concentration of extractant is between and optionally includes any two of the following values: 0.1 M, 0.25 M, 0.5 M, 0.75 M, 1 M, 1.5 M, 2 M, 2.5 M, 3 M, 3.5 M, 4 M, 4.5 M, 5 M, 5.5 M, 6 M, 6.5 M, 7 M, and 7.4 M. The upper limit of the concentration range is typically determined by the solubility of the extractant in the aqueous solution at the temperature of the contacting step. Typically, higher concentrations of extractant may be used at higher temperatures. The use of higher concentrations of extractant may require smaller volumes of aqueous solution and produce smaller volumes of leachate solution in the process, which may be advantageous over the use of larger quantities of aqueous solution having lower concentrations of extractant.

In one embodiment, the extractant is malonic acid, and the aqueous solution has a concentration of malonic acid between about 0.1 M and about 7.4 M. In one embodiment, the extractant is a malonic acid salt, and the aqueous solution has a concentration of malonic acid salt between about 0.1 M and about 7.4 M. In one embodiment, the extractant is a mixture of malonic acid and a malonic acid salt, and the aqueous solution has a concentration of extractant between about 0.1 M and about 7.4 M based on the sum of the malonic acid and the malonic acid salt.

In one embodiment, the extractant is citric acid, and the aqueous solution has a concentration of citric acid between about 0.1 M and about 7.4 M. In one embodiment, the extractant is a citric acid salt, and the aqueous solution has a concentration of citric acid salt between about 0.1 M and about 7.4 M. In one embodiment, the extractant is a mixture of citric acid and a citric acid salt, and the aqueous solution has a concentration of extractant between about 0.1 M and about 7.4 M based on the sum of the citric acid and the citric acid salt.

The relative amounts of the aqueous solution of the extractant and the iron contained in the substrate material can vary within a suitable range. The extensiveness of the suitable range reflects the various ranges of iron content which may be present in the substrate materials. In some embodiments, the molar ratio of the extractant to the iron of the substrate material is between and optionally includes any two of the following values: 0.1:1; 0.5:1; 1:1; 2:1; 5:1; 10:1; 12:1; 15:1; 20:1; 50:1; 75:1; 100:1; 250:1; 500:1; 1000:1; 5000:1; 10,000:1; 50,000:1; 100,000:1; 200,000:1; 300,000:1; 400,000:1; and 500,000:1. In some embodiments, the molar ratio is between 0.5:1 and 50:1. In some embodiments, the molar ratio is between 0.5:1 and 500:1. In some embodiments, the molar ratio is between 0.1:1 and 12:1. In some embodiments, the molar ratio is between 10:1 and 100:1. In some embodiments, the molar ratio is between 500:1 and 250,000:1. The selected range reflects optimization of the contacting step within a selected reactor configuration, for example balancing the volume of the aqueous solution of the extractant with the amount of iron obtained in the leachate. For the processes disclosed herein, the temperature, extractant, concentration of the extractant in the aqueous solution, contacting time, particle size of the substrate material, and iron content of the substrate material are related; thus the process variables may be adjusted as necessary within appropriate limits to optimize the processes as disclosed herein.

In one embodiment, during the contacting step the aqueous solution of the extractant is present in an amount whereby the molar ratio of the extractant to the iron of the substrate material is between about 0.1:1 and about 100:1.

The processes disclosed herein can be performed in any suitable vessel, such as a batch reactor or a continuous reactor. Optionally, the suitable vessel may be equipped with a means, such as impellers, for agitating the substrate material, leachate, and solids. Contacting the substrate with an aqueous solution of extractant may be performed in a batch, continuous, or semi-continuous manner. The contacting step may be performed in one reactor, or in a series of reactors. Suitable reactor types include, for example, continuous stirred-tank, packed bed, and moving bed reactors. Reactor design is discussed, for example, by Lin, K.-H., and Van Ness, N. C. (in Perry, R. H. and Chilton, C. H. (eds.), Chemical Engineer's Handbook, 5th Edition (1973) Chapter 4, McGraw-Hill, NY).

In one embodiment, the contacting is performed in a batch manner and the molar ratio of the extractant to the iron contained in the substrate material is between 0.1:1 and 12:1. In one embodiment, the contacting is performed in a continuous manner and the molar ratio of the extractant to the iron contained in the substrate material is between 10:1 and 100:1.

Contacting the substrate material with an aqueous solution of extractant may be performed at a temperature between about 25° C. and about 160° C. In some embodiments, the temperature is between and optionally includes any two of the following values: 25° C., 30° C., 40° C., 50° C., 60° C., 70° C., 80° C., 90° C., 100° C., 110° C., 120° C., 130° C., 140° C., 150° C., and 160° C. In some embodiments, the temperature is between about 25° C. and about 130° C. In some embodiments, the temperature is between about 30° C. and about 120° C. In some embodiments, the temperature is between about 40° C. and about 110° C. During the contacting step, the temperature may be kept constant or varied. Increasing the temperature of the aqueous solution may increase the solubility of the extractant in the solution, thus allowing higher concentrations to be reached at higher temperature. Higher contacting temperatures and higher concentrations of extractant may permit use of shorter reaction times to form the leachate, and may be advantageous.

Contacting the substrate material with an aqueous solution of extractant may be performed at a pressure between reduced atmospheric pressure and the autogenous pressure at the temperature of the contacting step. In some embodiments, the pressure is between and optionally includes any two of the following values: 0.01 kPa, 205 kPa (15 psig), 308 kPa (30 psig), 446 kPa (50 psig), 790 kPa (100 psig), 1135 kPa (150 psig), 1480 kPa (200 psig), and 1825 kPa (250 psig). In some embodiments, the pressure is between about 0.01 kPa and about 205 kPa. In some embodiments, the pressure is between about 0.01 kPa and 1825 kPa. In some embodiments, the contacting is done under autogenous pressure. Optionally, the contacting may be performed under an inert gas such as nitrogen or argon. The choice of operating pressure may be related to the temperature of the contacting step and is often influenced by economic considerations and/or ease of operation.

The contacting of the substrate material with an aqueous solution of extractant is performed for a time sufficient to form an aqueous leachate comprising iron and titanium, and solids comprising titanium, wherein the leachate has a titanium content of 25 weight percent or less, based on the sum of the iron and the titanium contents of the leachate on a weight basis. In some embodiments, the contacting is performed for a period of time between and optionally including any two of the following values: 0.1 h, 0.5 h, 1 h, 2 h, 3 h, 6 h, 12 h, 18 h, 24 h, 48 h, 72 h, 96 h, 120h, 144 h, and 168 h. In some embodiments, the contacting is performed for a period of time between 0.1 h and 48 hours. In some embodiments, the contacting is performed for about 6 h to about 24 hours. In general, longer contacting times may provide a leachate with a higher concentration of iron. The optimal amount of contacting time can vary, depending upon conditions such as temperature, extractant, concentration of the extractant in the aqueous solution, iron content of the substrate material, and particle size of the substrate material.

The leachate formed during the contacting step may be separated from the solids using techniques known in the art, for example by filtration or centrifugation. In some embodiments, the process further comprises the steps of b) separating the solids from the leachate to obtain separated solids; and c) optionally, washing the separated solids with water. Optionally, the separated solids may be washed with water to remove any leachate remaining in contact with the solids, and the washings may be combined with the leachate if desired.

The separated solids are titanium-enriched and iron-depleted relative to the substrate material. In some embodiments, the process further comprises using the separated solids obtained in step b) or step c) in a process for producing titanium dioxide pigment. Processes for producing titanium dioxide pigment are known, for example as disclosed in J. Barksdale, Titanium: Its Occurrence, Chemistry, and Technology, 1949, Ronald Press Co.

In one embodiment, a titanium-enriched material is obtained by a process comprising the steps:

i) contacting a substrate material comprising iron and titanium with an aqueous solution of an extractant selected from the group consisting of malonic acid, a malonic acid salt, citric acid, a citric acid salt, and mixtures thereof, at a temperature between about 25° C. and about 160° C. for a time sufficient to form a leachate comprising iron and titanium, and solids comprising titanium;

wherein the leachate has a titanium content of 25 weight percent or less, based on the sum of the iron and the titanium contents of the leachate on a weight basis; and

ii) separating the solids from the leachate to obtain separated solids; wherein the separated solids are titanium-enriched relative to the substrate material.

In some embodiments, the process further comprises step d) recovering iron from the leachate obtained by contacting the substrate material with an aqueous solution of an extractant as disclosed herein. The iron in the leachate could be recovered as iron oxide and/or iron oxyhydroxide by four methods. In the first method, the iron-containing leachate could be contacted with a reducing agent, such as iron, tin or zinc metal powder, to convert soluble iron (III) ions to insoluble iron (II) ions, for example in U.S. Pat. Nos. 2,047,208 and 2,049,504. The reduced iron would precipitate and could be separated by filtration, then dried and calcined to produce iron oxide powder for use as red, brown, or orange pigments. Alternatively, in the second method the leachate containing iron could be heated to evaporate the water, and the iron-containing solids, dried, then calcined in air at a temperature sufficiently high enough to decompose the malonate to CO₂ and H₂O and leave behind an iron oxide powder for use as feedstocks for iron metal or iron based pigments. In the third method, the iron-containing leachate could be mixed with a base, such as sodium hydroxide, to precipitate an insoluble iron oxyhydroxide which could be calcined to form iron oxide powder. In the fourth method, the iron-containing leachate could be mixed with sulfuric acid to form iron sulfate, contacted with a reducing agent to form insoluble iron (II) sulfate, i.e. gypsum, and separated by filtration.

### EXAMPLES

The processes described herein are illustrated in the following examples. From the above discussion and these examples, one skilled in the art can ascertain the essential characteristics of the processes disclosed herein, and without departing from the spirit and scope thereof, can make various changes and modifications to adapt to various uses and conditions.

The following abbreviations are used in the examples: “° C.” means degrees Celsius; “wt %” means weight percent; “ppm” means parts per million; “g” means gram; “mL” means milliliter; “M” means molar, which is moles per liter; “kPa” means kilopascals; “Ex” means Example, “Comp Ex” means Comparative Example.

### Materials

All commercial materials were used as received unless stated otherwise. Malonic acid (H₄C₃O₄, catalog #M1296), citric acid (H₈C₆O₇, catalog #251275), oxalic acid (H₄C₂O₄.2H₂O, catalog #247537), and ammonium binoxalate [(NH₄)HC₂O₄.H₂O, catalog #09898) were obtained from Sigma Aldrich. Sulfuric acid, 98 wt % H₂SO₄ (catalog #SX1244) was obtained from EMD.

Ilmenite containing 55.5 wt % TiO₂ and 42.4 wt % Fe₂O₃ was obtained from Iluka Resources LTD (Capel, Australia). The titanium and iron content of the ilmenite was determined by x-ray fluorescence analysis and reported as the common oxides, as widely practiced. This data provides an iron to titanium weight ratio of about 0.92.

Rutile TiO₂ (catalog #43047) was obtained from Alfa Aesar. The composition of the rutile TiO₂ as specified by Alfa Aesar is shown in Table 1.

TABLE 1
Composition of Rutile TiO₂.

| Oxide | Amount (wt %) |
|---|---|
| TiO₂ | 99.71 |
| Al₂O₃ | 0.007 |
| Fe₂O₃ | 0.003 |
| K₂O | 0.021 |
| MgO | 0.002 |
| P₂O₅ | 0.036 |
| SiO₂ | <0.001 |
| SO₃ | 0.002 |
| ZrO₂ | 0.006 |
| Na₂O | 0.003 |

### Analytical Methods

The iron and titanium concentrations of the leachates obtained in Examples 1-5 were determined by Inductively Coupled Plasma Spectrometry.

### Example 1

### Contacting FeTiO₃ with 6 M Malonic Acid Solution at Reflux

In a 500 mL round bottom flask equipped with a mechanical stirrer and a condenser under a nitrogen blanket were combined 62.44 g H₄C₃O₄ and 102.28 g deionized water to give a 6 M malonic acid solution. The solution was heated to reflux, which occurred at about 94-97° C. 15.18 Grams of ilmenite ore (FeTiO₃) was then added to the solution. The mixture was allowed to digest for six days, during which time the solution turned to a dark chocolate color. The contents of the flask were then filtered to separate the leachate solution from the solids. The solids were washed with 46.45 g of deionized water, which was not combined with the leachate. The washed solids were black in color and the leachate was a light peach color. The iron and titanium concentrations of the leachate are given in Table 2.

### Example 2

### Contacting FeTiO₃ with 7.4 M Malonic Acid Solution at Reflux

In a 250 mL round bottom flask equipped with a mechanical stirrer and a condenser under a nitrogen blanket were combined 39.03 g H₄C₃O₄ and 52.69 g deionized water. The solution was heated to 60° C., then an additional 61.82 g of H₄C₃O₄ and 15.60 g deionized water were added to the flask. The solution was heated to reflux, which occurred at 105° C. To the solution, 15.19 g of ilmenite and an additional 14.85 g deionized water were added, giving a 7.4 M malonic acid solution. The mixture was allowed to digest for three days, during which the solution turned to a dark chocolate color. The contents of the flask were then filtered to separate the leachate solution from the solids. The filtered solids were black in color and the solution was a light yellow/orange in color. The iron and titanium concentrations of the leachate are given in Table 2.

### Example 3

### Contacting FeTiO₃ with 6 M Malonic Acid Solution at 50° C.

In a 500 mL round bottom flask equipped with a mechanical stirrer and a condenser under a nitrogen blanket were combined 64.0 g H₄C₃O₄ and 100.9 g deionized water to give a 6 M malonic acid solution. The solution was heated to 50° C. The initial pH of the solution before heating was measured as pH 1 by pH paper. To the solution, 15.191 g of ilmenite was added. The mixture was allowed to digest for 25.5 hours at 50° C. The contents of the flask were then filtered to separate the leachate solution from the solids. The filtered solids were black in color and the leachate was a light yellow in color. The iron and titanium concentrations of the leachate are given in Table 2.

### Example 4

### Contacting Rutile TiO₂ with 6 M Malonic Acid Solution at 50° C.

In a 500 mL round bottom flask equipped with a mechanical stirrer and a condenser under a nitrogen blanket were combined 62.6 g H₄C₃O₄ and 110.2 g deionized water to give a 6 M malonic acid solution. The solution was heated to 50° C. To the mixture, 7.817 g of rutile TiO₂ containing 30 ppm Fe₂O₃ was added. The mixture was allowed to digest for 24 hours at 50° C. The flask contents were then filtered to separate the leachate solution from the solids. The filtered solids were white in color and the solution was clear in color. The iron and titanium concentrations of the leachate are given in Table 2.

### Example 5

### Contacting FeTiO₃ with 1 M Malonic Acid Solution at 50° C.

In a 500 mL round bottom flask equipped with a mechanical stirrer and a condenser under a nitrogen blanket were combined 10.5 g H₄C₃O₄ and 110.0 g deionized water to give a 1 M malonic acid solution. The solution was heated to 50° C. The initial pH of the solution was measured before heating as pH 1 by pH paper. To the mixture, 15.30 g of ilmenite was added. The mixture was allowed to digest for 24 hours at 50° C. The flask contents were then filtered to separate the leachate solution from the solids. The filtered solids were black in color and the solution was a very light yellow in color. The iron and titanium concentrations of the leachate are given in Table 2.

### Example 6

### Contacting FeTiO₃ with 3 M Citric Acid Solution at Reflux

In a 500 mL round bottom flask equipped with a mechanical stirrer and a condenser under a nitrogen blanket were combined 64.05 g H₈C₆O₇ and 98.77 g deionized water to give a 3 M citric acid solution. The solution was heated to reflux, which occurred at about 98° C. To the solution, 25.74 g of ilmenite was added. The mixture was allowed to digest for 24 hours at 98° C., during which time it turned to a brown color. The flask contents were then filtered to separate the leachate solution from the solids. Solids were washed from the reactor using 61.75 g of deionized water, which was combined with the leachate solution. The iron and titanium concentrations of the leachate combined with the wash water are given in Table 2.

### Comparative Example A

### Contacting FeTiO₃ with 6 M Oxalic Acid Solution at Reflux

In a 500 mL round bottom flask equipped with a mechanical stirrer and a condenser under a nitrogen blanket were combined 50.44 g H₄C₂O₄.2H₂O, 56.83 g (NH₄)HC₂O₄.H₂O), and 108.04 g deionized water to give a 6 M oxalic acid solution. The solution was heated to reflux, which occurred around 103-104° C. To the mixture, 15.20 g of ilmenite was added. The mixture was allowed to digest for 72 hours at reflux. The flask contents were then filtered to separate the leachate solution from the solids. The filtered solids were grey/yellow in color and the solution was dark amber in color. The iron and titanium concentrations of the leachate are given in Table 2.

### Comparative Example B

### Contacting FeTiO₃ with 18 M Sulfuric Acid at Reflux

To a 500 mL round bottom flask equipped with a mechanical stirrer and a condenser under a nitrogen blanket were added 147.15 g of 98 wt % sulfuric acid. The solution was heated to 170° C. To the solution, 75.43 g of ilmenite was added. The mixture was allowed to digest for 1 hour, during which time the mixture became a thick gray mass. To the digestion mass, 402 g of deionized water was added, and the mixture was allowed to stir for about 16 hours. The mixture was then filtered. The filtered solids were black in color and the leachate solution was dark amber in color. The iron and titanium concentrations of the leachate are given in Table 2.

TABLE 2
Amounts of Iron and Titanium in the Leachates of
Examples 1-6 and Comparative Examples A and B

| | | | Concentration* | Wt % Fe* | Wt % Ti* | Fe/Ti |
|---|---|---|---|---|---|---|
| | Concentration | Concentration | (ppm) of | based on | based on | Ratio* |
| Example | (ppm) of Fe | (ppm) of Ti | (Fe + Ti)^{#} | (Fe + Ti)^{#} | (Fe + Ti)^{#} | (weight) |
| 1 | 1876 | <1 | 1877 | 99.9 | 0.05 | >1876 |
| 2 | 1082 | <1 | 1083 | 99.9 | 0.09 | >1082 |
| 3 | 203 | 2 | 205 | 99.0 | 0.97 | 101.5 |
| 4 | 44 | 7 | 51 | 86.3 | 13.7 | 6.3 |
| 5 | 163 | 3 | 166 | 98.2 | 1.81 | 54.3 |
| 6 | 310 | 85 | 395 | 78.4 | 21.5 | 3.6 |
| Comp Ex A | 1550 | 2880 | 4430 | 35.0 | 65.0 | 0.54 |
| Comp Ex B | 2710 | 2420 | 5130 | 51.8 | 47.2 | 1.12 |

Notes:
*For Examples 1 and 2, the Ti concentration in the leachate was defined to be 1 ppm for the calculation of the concentration of Fe + Ti, weight percent Fe, weight percent Ti, and Fe/Ti ratio.
^{#}“(Fe + Ti)” means the sum of the iron and titanium contents of the leachate.

The data in Table 2 demonstrate the effectiveness of contacting a substrate material comprising iron and titanium with an aqueous solution of malonic acid or citric acid to dissolve iron preferentially over titanium, forming a leachate containing significantly more iron than titanium. Results for Examples 1 and 2 show that contacting an aqueous solution of malonic acid with ilmenite at temperatures in the range of about 94° C. to about 105° C. formed leachates having an iron content above 99 wt % and a titanium content below 0.1 wt %, based on the sum of the iron and titanium in the leachate on a weight basis. The results for Examples 3 and 5 demonstrate that contacting a 1 M or 6 M malonic acid solution with ilmenite at about 50° C. provided leachates having an iron content of at least 98 wt % and a titanium content of less than 2 wt % (Example 5) or less than 1 wt % (Example 3). In Example 6, the use of citric acid as the extractant formed a leachate containing 78.4 wt % iron and 21.5 wt % titanium. Finally, results for Example 4, in which rutile titanium dioxide containing 30 ppm Fe₂O₃ was contacted with an aqueous solution of malonic acid at 50° C., show a leachate which contained 86.3 wt % iron and only 13.7 wt % titanium, even though the substrate material was composed primarily of titanium dioxide.

In contrast, Comparative Examples A and B provided leachates which contained more titanium than iron (Comparative Example A) or nearly equal amounts of titanium and iron (Comparative Example B) when ilmenite was contacted with an aqueous solution of oxalic acid or with concentrated sulfuric acid.

What is claimed is:

1. A process comprising the step:
a) contacting a substrate material comprising iron and titanium with an aqueous solution of an extractant selected from the group consisting of malonic acid, a malonic acid salt, citric acid, a citric acid salt, and mixtures thereof, at a temperature between about 25° C. and about 160° C. for a time sufficient to form an aqueous leachate comprising iron and titanium, and solids comprising titanium;
wherein the leachate has a titanium content of 25 weight percent or less, based on the sum of the iron and the titanium contents of the leachate on a weight basis.

2. The process of claim 1, further comprising the steps:
b) separating the solids from the leachate to obtain separated solids; and
c) optionally, washing the separated solids with water.

3. The process of claim 1, wherein the substrate material comprises ilmenite ore.

4. The process of claim 1, wherein the substrate material comprises titanyl hydroxide cake.

5. The process of claim 1, wherein the substrate material comprises titanium dioxide pigment.

6. The process of claim 5, wherein the titanium dioxide pigment comprises rutile titanium dioxide, anatase titanium dioxide, or a mixture thereof.

7. The process of claim 1, wherein the aqueous solution has a concentration of the extractant between about 0.1 M and about 7.4 M.

8. The process of claim 1, wherein the aqueous solution of the extractant is present in an amount whereby the molar ratio of the extractant to the iron of the substrate material is between about 0.1:1 and about 500,000:1.

9. The process of claim 1, wherein the contacting is performed at a pressure between about 0.01 kPa and 1825 kPa.

10. The process of claim 1, wherein the contacting is performed in a continuous manner.

11. The process of claim 1, wherein the contacting is performed in a batch manner.

12. The process of claim 1, further comprising using the solids comprising titanium in a process for producing titanium dioxide pigment.

13. The process of claim 2, further comprising using the separated solids obtained in step b) or step c) in a process for producing titanium dioxide pigment.

14. The process of claim 1, wherein the extractant is citric acid.

15. The process of claim 1, wherein the extractant is malonic acid.

16. The process of claim 15, wherein the leachate has a titanium content of 9 weight percent or less.

17. The process of claim 1, wherein the leachate has a titanium content of 5 weight percent or less.

18. The process of claim 1, wherein the substrate material contains less than 0.1 weight percent iron.

19. The process of claim 1, wherein the substrate material contains from about 0.0001 weight percent iron to about 55 weight percent iron.

20. The process of claim 2, further comprising step d) recovering iron from the leachate obtained in step b).

21. The process of claim 1, wherein the extractant is malonic acid and the temperature is between about 50° C. and about 100° C., and wherein the aqueous solution has a concentration of malonic acid between about 3 M and about 7.4 M.

22. A titanium-enriched material obtained by a process comprising the steps:
i) contacting a substrate material comprising iron and titanium with an aqueous solution of an extractant selected from the group consisting of malonic acid, a malonic acid salt, citric acid, a citric acid salt, and mixtures thereof, at a temperature between about 25° C. and about 160° C. for a time sufficient to form a leachate comprising iron and titanium, and solids comprising titanium;
wherein the leachate has a titanium content of 25 weight percent or less, based on the sum of the iron and the titanium contents of the leachate on a weight basis; and
ii) separating the solids from the leachate to obtain separated solids;
wherein the separated solids are titanium-enriched relative to the substrate material.
